(19) United States
(12) Patent Application Publication
(10) Pub. No.: US 2016/0231790 A1
(43) Pub. Date: Aug. 11, 2016

(54) COMPUTER COOLING MODULE ASSEMBLY FOR STACKED PRINTED CIRCUIT BOARDS

(71) Applicant: PERFECTRON CO., LTD. TAIWAN BRANCH (B.V.I), NEW TAIPEI CITY (TW)

(72) Inventor: Yen-Yun Ting, NEW TAIPEI CITY (TW)

(21) Appl. No.: 14/618,382

(22) Filed: Feb. 10, 2015

(51) Int. Cl. G06F 1/20

(52) U.S. Cl. CPC G06F 1/20

(57) ABSTRACT

A computer cooling module assembly for stacked printed circuit boards housed a plurality of printed circuit boards that are stacked over each other includes an open finned frame to hold the printed circuit boards. The finned frame includes two corresponding planes to hold a plurality of positioning support racks that are symmetrical and equally spaced from each other, at least one heat conduction board leaned on the positioning support racks to transmit heat generated by electronic elements on the printed circuit boards to the finned frame, and two covering boards to separate the interior and the exterior of the finned frame. Thus the heat generated by the electronic elements on the printed circuit boards can be transmitted to the finned frame through the heat conduction board. The finned frame includes fins to form a maximum surface area to increase heat conduction cooling area.

### FIELD OF THE INVENTION

The present invention relates to a computer cooling structure for printed circuit boards and particularly to a computer cooling structure for stacked printed circuit boards.

### BACKGROUND OF THE INVENTION

Electronic elements in a computer generate heat during operation, hence a cooling device has to be installed to maintain the operation temperature within an allowable range. Too high of the operation temperature could cause performance deterioration or even failure of the computer. However, the electronic elements or components in the computer that generate greater amount of heat such as central processing unit (CPU), display card or hard disk drive (HDD) require more efficient cooling at the same time to maintain normal operation. To resolve the cooling problem the most common approach is dispersing heat through heat conduction or heat convection. On heat conduction, the general approach is installing cooling fins above the heat generating elements mentioned above. On heat convection, cooling fans are employed, or cooling tubes that provide both heat conduction and heat convection are used to disperse the heat. Hence, the heat generated by the heat generating elements or components can be transmitted to the cooling fins and dispelled via convection.

It is to be noted that because of rapid advance in technology the process speed of the electronic elements or components such as CPU, display card and HDD is much faster than the old ones. The heat generated by the related products also is much greater. Based on the present technique to achieve cooling via heat conduction and heat convection, the design mainly aims to implement inside the computer casing. Namely, the present technique mainly connects a cooling fin above the electronic elements or components such as CPU, HDD or the like, then generates convection through a cooling fan installed outside the computer casing to dispel the heat to an ambience outside the computer. However, due to the space within the computer casing is very limited, the cooling area formed on the cooling fin is relatively small. Moreover, the cooling fin is still sealed inside the computer casing. As a result, cooling efficacy of the heat conduction and heat convection is seriously affected. In addition, the air fan also can be divided into two types, an axial air fan or a centrifugal air fan. The axial air fan draws airflow into vanes which spin to blow the airflow outward in parallel with the central axis of the wheel hub. It has features of smaller static pressure and greater airflow volume. On the other hand, the centrifugal air fan drives a circular disc type wheel hub to draw airflow and blow the airflow radially outward through the vanes via spinning dynamic power. It has features of a higher static pressure than the axial air fan, but also generating much greater noise than the axial air fan. As a result, whether to generate convection for cooling via the axial air fan or the centrifugal air fan creates the problem of noise generation, hence cannot fully meet user's requirement.

### SUMMARY OF THE INVENTION

The primary object of the present invention is to solve the aforesaid problems of the conventional techniques of undesirable cooling efficacy caused by inadequate cooling area and provide a cooling structure that is noiseless and has a greater heat conduction cooling area to meet users' requirements.

To achieve the foregoing object the present invention provides a computer cooling module assembly for stacked printed circuit boards. The computer cooling module assembly houses a plurality of printed circuit boards that are stacked over each other and includes an open finned frame to hold the printed circuit boards. The finned frame includes two corresponding planes to form a plurality of positioning support racks in a symmetrical and equally spaced manner, at least one heat conduction board leaned on the positioning support racks to transmit heat generated by electronic elements on the printed circuit boards to the finned frame, and two covering boards to separate the interior and the exterior of the finned frame.

In one aspect the finned frame and each covering board are interposed by a cooling tube.

In another aspect the finned frame and each covering board are shaped respectively in a concave and semi-arched surface according to the profile of the cooling tube to form a tube installation trough and a tube butting trough to couple with the cooling tube.

In yet another aspect each printed circuit board has a connector to form electrical connection with another printed circuit board stacked above or below thereof, and the heat conduction board has at least one connector slot passed through by the connector.

In yet another aspect the finned frame includes at least one telecommunication connection interface to transmit telecommunication signals of the printed circuit boards, and the heat conduction board has at least one conductive wire slot to allow a conductive wire of the telecommunication connection interface to pass through.

In yet another aspect the heat conduction board and the positioning support racks are interposed by at least one positioning fastener to fasten the heat conduction board.

In yet another aspect the finned frame includes a conduction base at the inside bottom in contact with the heat conduction board, and the heat conduction board and the printed circuit boards are interposed by at least one conduction pad to transmit the heat of the electronic elements on the printed circuit boards to the heat conduction board.

By means of the technique set forth above, compared with the conventional techniques, the invention can provide many advantages, notably:

1. The heat generated by the electronic elements on the printed circuit boards can be transmitted to the finned frame through the heat conduction board with the fins of the finned frame to form a maximum surface area to increase heat conduction cooling area to achieve faster and more efficient cooling efficacy without generating noise.

2. The invention, by incorporating with the cooling tube interposed between the finned frame and the covering boards, can achieve faster and more substantial cooling effect.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of an embodiment of the invention.

FIG. 2 is an exploded view of the invention according to FIG. 1.

FIGS. 3 through 16 are fragmentary perspective views and plane views showing assembly processes of the invention according to FIG. 1.

### DETAILED DESCRIPTION OF THE PREFERRED EMBODIMENT

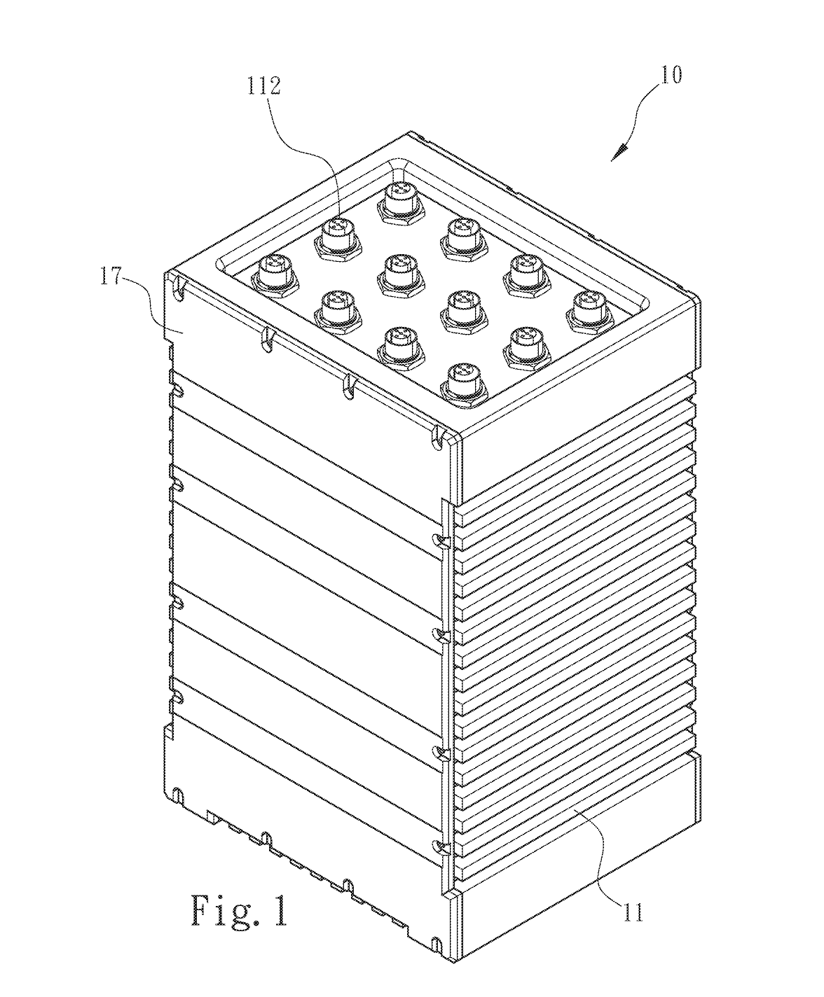

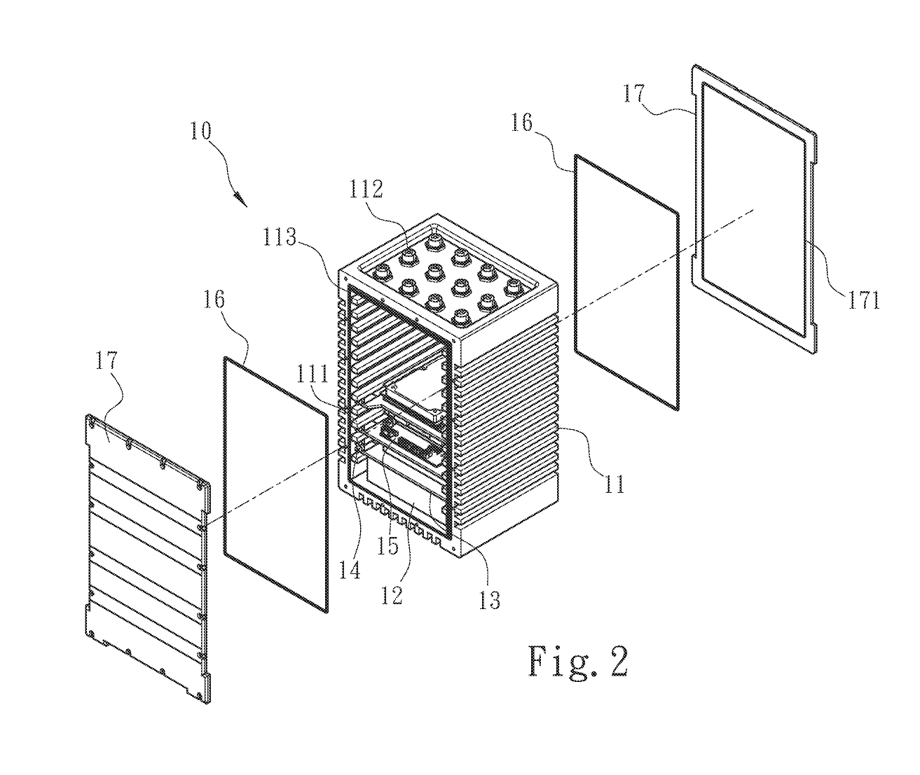

Please refer to FIGS. 1 and 2 for an embodiment of the invention. The computer cooling module assembly 10 aims to house a plurality of printed circuit boards 15 that are stacked over each other. It includes an open finned frame 11 to hold the printed circuit boards 15. The finned frame 11 includes a plurality of fins located on outer surfaces (including the bottom surface) and a plurality of positioning support racks 111 on two corresponding planes that are symmetrical and equally spaced from each other, and also at least one heat conduction board 13 leaned on the positioning support racks 111 to transmit heat generated by electronic elements on the printed circuit boards 15 to the finned frame 11. The heat conduction board 13 and the positioning support racks 111 are interposed by at least one positioning fastener 14 to fasten the heat conduction board 13. The finned frame 11 further has a conduction base 12 at the inside bottom in contact with the heat conduction board 13 to facilitate transmission of the heat from the lowest heat conduction board 13 toward the bottom side of the finned frame 11. The heat conduction board 13 and the printed circuit boards 15 are interposed by at least one conduction pad 121 to transmit the heat of the electronic elements on the printed circuit boards 15 to the heat conduction board 13. The computer cooling module assembly 10 further includes two covering boards 17 to separate the interior and the exterior of the finned frame 11. The finned frame 11 and each covering plate 17 are interposed by a cooling tube 16 which is made of metal tube of a higher heat conductivity and formed in a hollow and small tubular size with two closed ends. The cooling tube 16 contains a small amount of liquid and has the inner wall treated to form a capillary structure. When the cooling tube 16 is partly in contact with a heat generation source the liquid inside is heated and reaches a boiling point to gasify and evaporate. The evaporated gas moves to the upper portion of the cooling tube 16 and releases the heat through the tubular wall, then resumes the liquid state and adheres to the tubular wall. Because of the capillary structure formed on the inner wall of the cooling tube the liquid flows downward through the capillary principle near the heat generation source at the lower side of the cooling tube 16. Thus a natural circulation cooling system is formed. Simply put, the liquid in the cooling tube 16 is gasified and evaporated; the gas flows in a convection manner and transmits heat to perform cooling by collaborating with the tubular wall; the cooled gas is condensed to liquid again, and flows back via capillary effect. Due to the heat transmission speed of the cooling tube 16 is much faster than that of copper or silver, and also no noise generation caused by air fans, hence can provide users a quiet and lower temperature operation environment. In addition, the finned frame 11 and each covering board 17 are formed respectively in a tube installation trough 113 and a tube butting trough 171 that are formed in a concave and semi-arched surface fashion according to the profile of the cooling tube 16 to couple therewith. Furthermore, each printed circuit board 15 has a connector 151 to form electrical connection with another printed circuit board 15 stacked on the upper side or the lower side. The heat conduction board 13 also has at least one connector slot 132 run through by the connector 151, and the finned frame 11 also has at least one telecommunication connection interface 112 to transmit telecommunication signals of the printed circuit boards 13. The heat conduction board 13 further has at least one conductive wire slot 131 to allow a conductive wire of the telecommunication connection interface 112 to pass through.

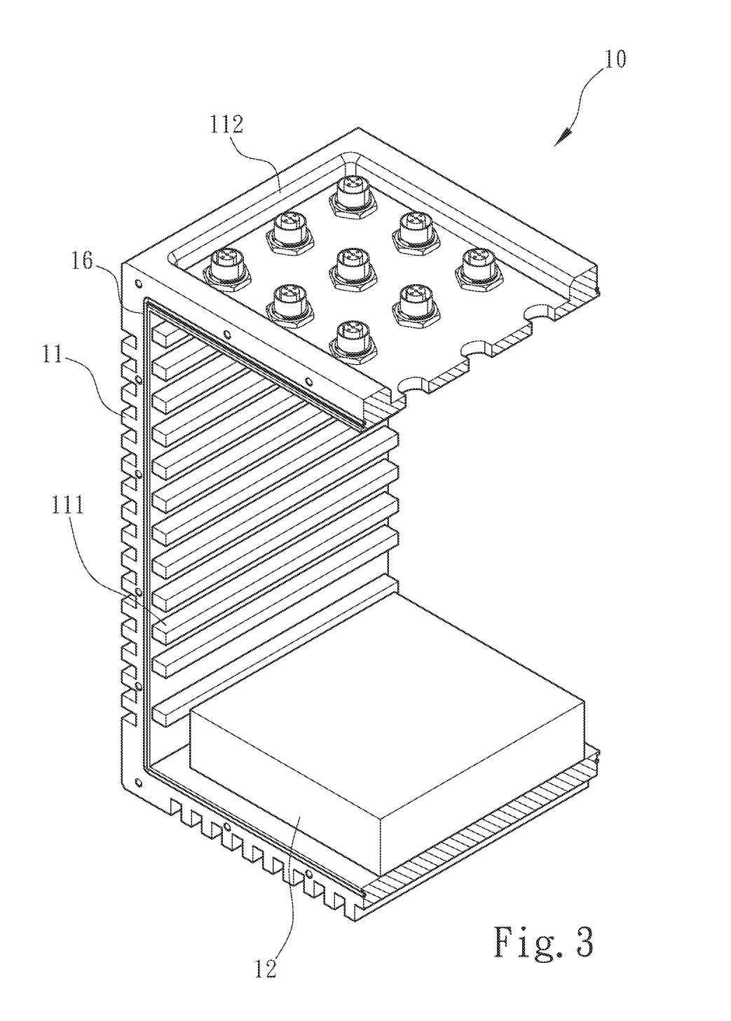

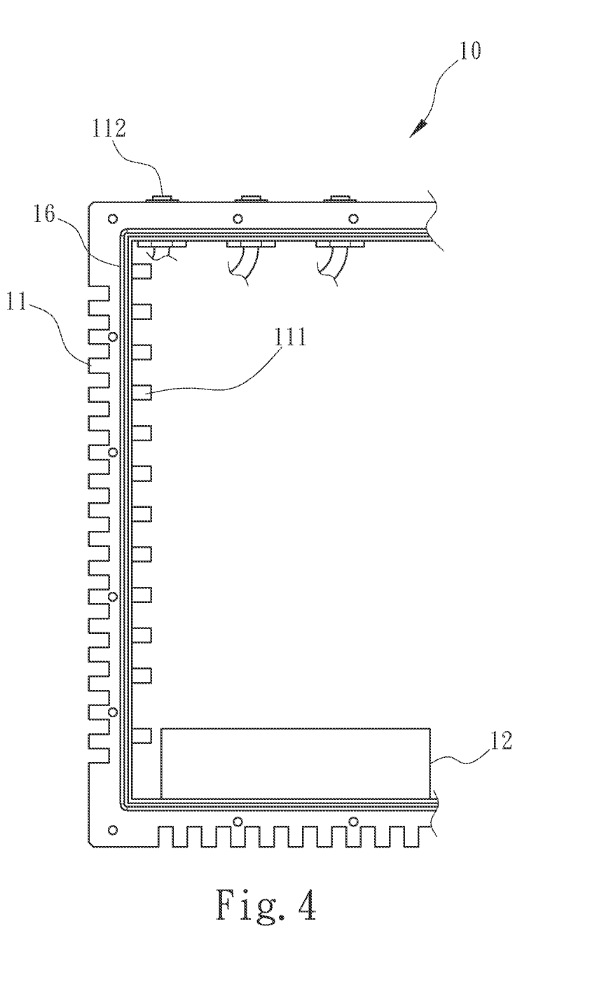

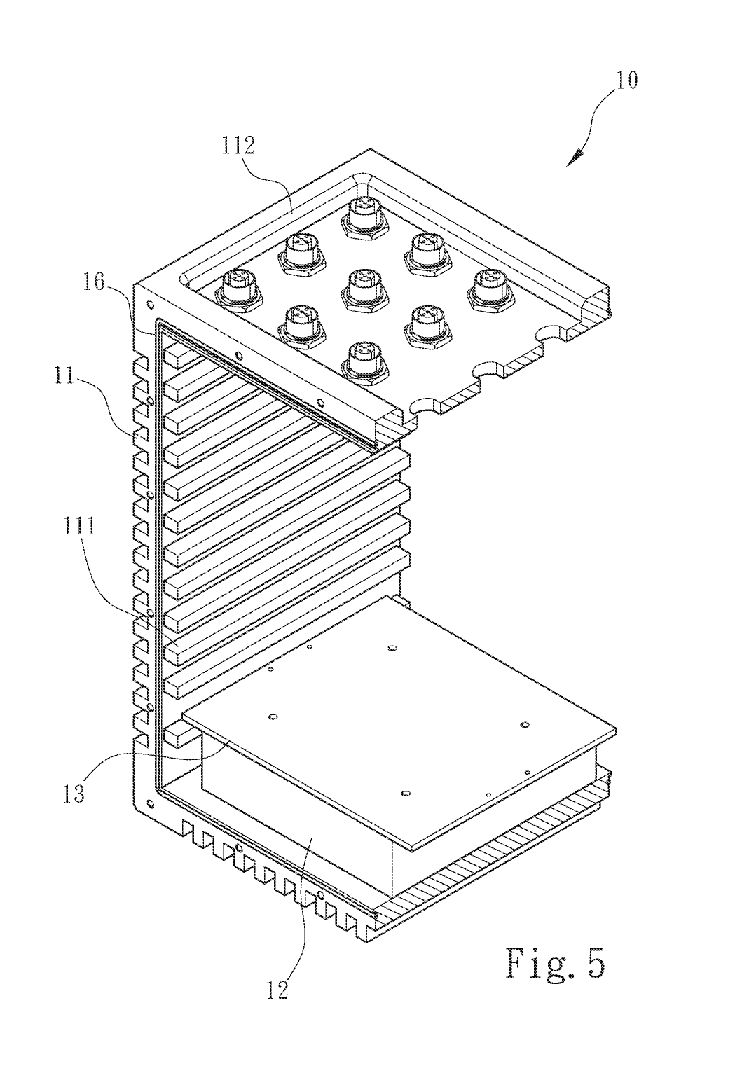

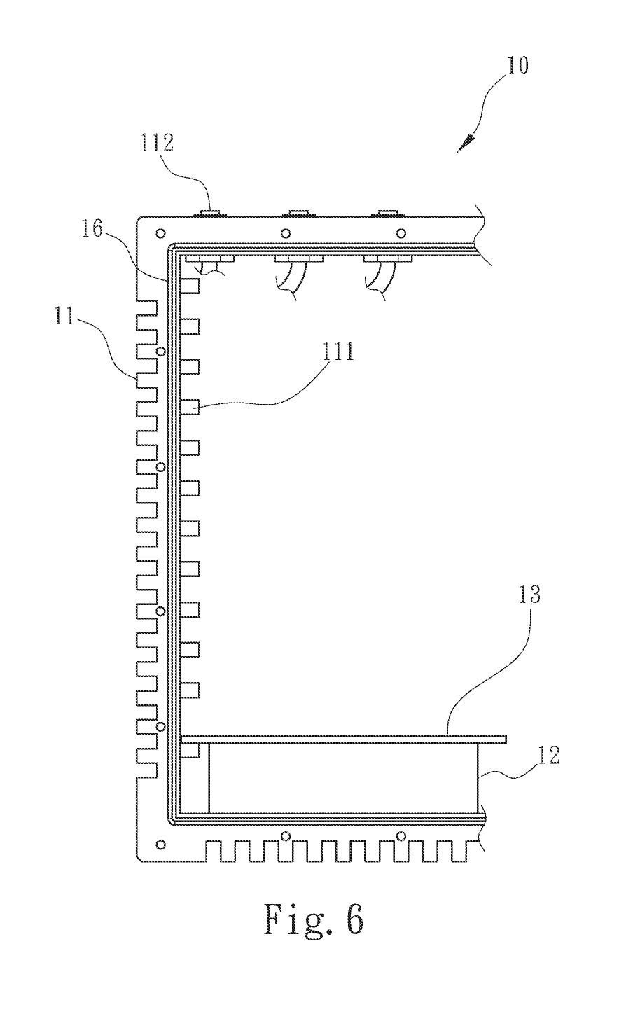

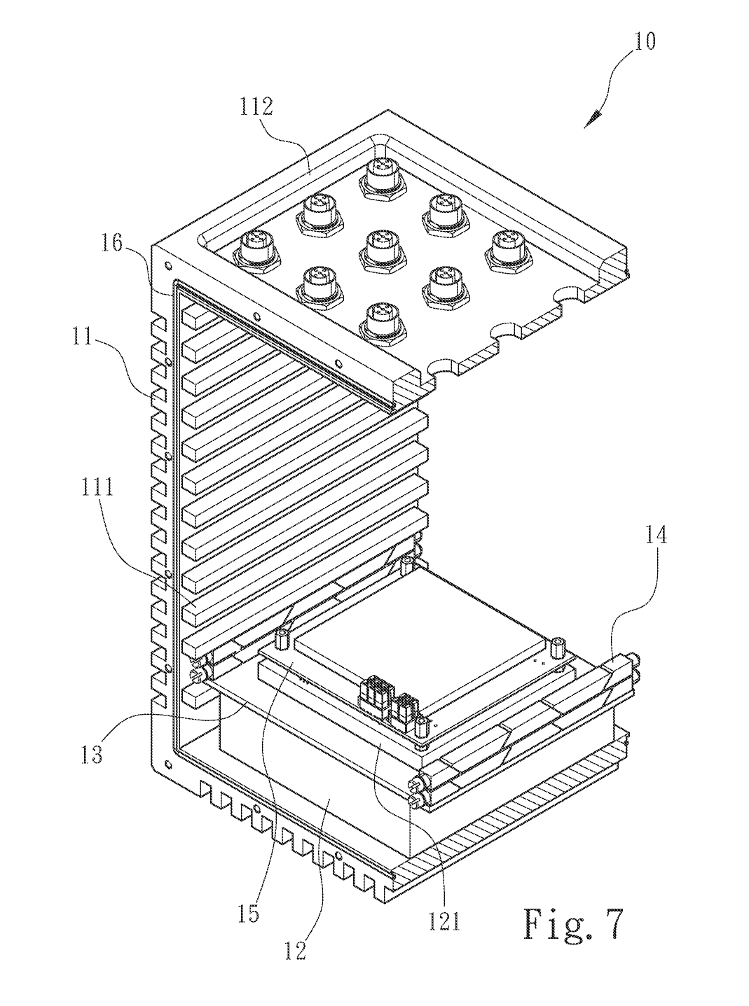

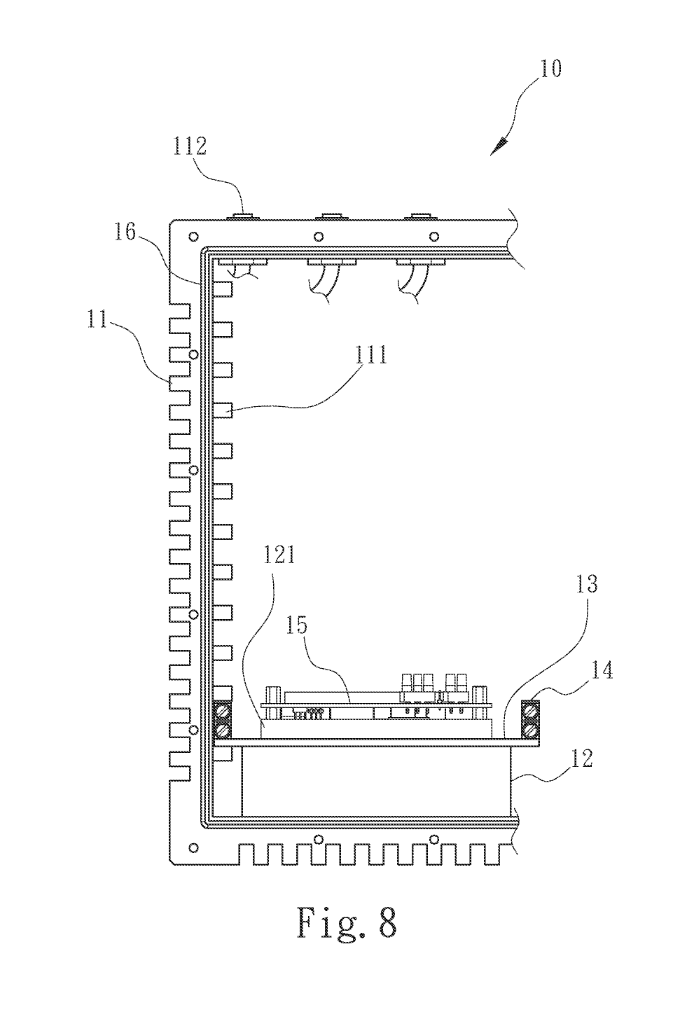

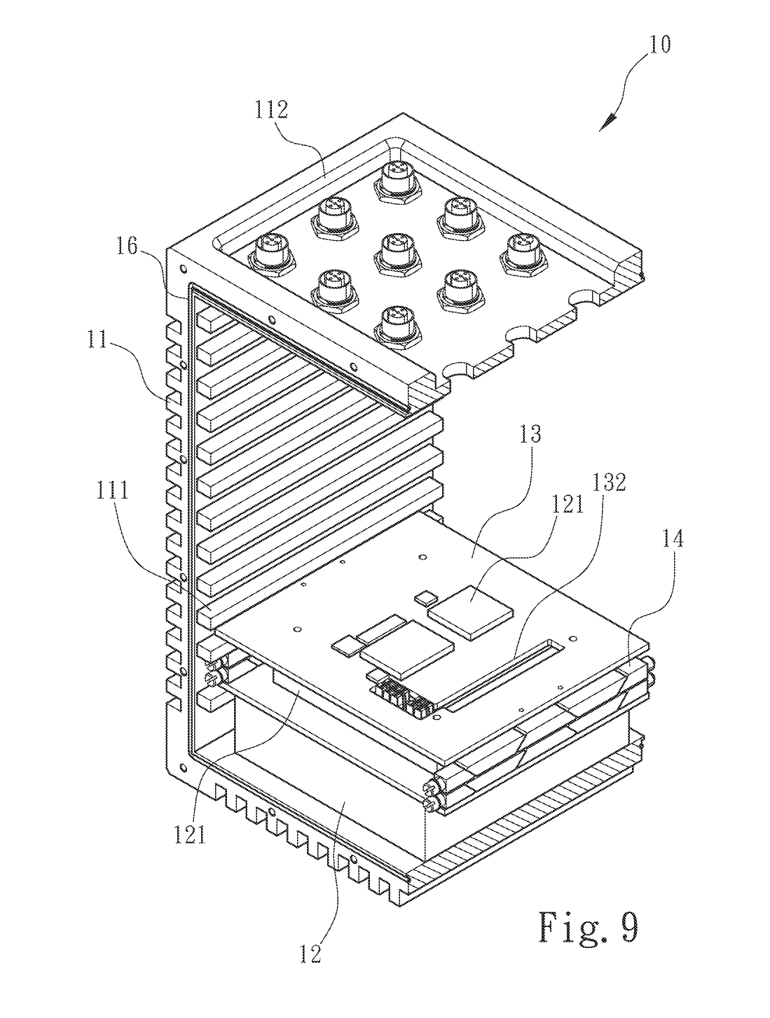

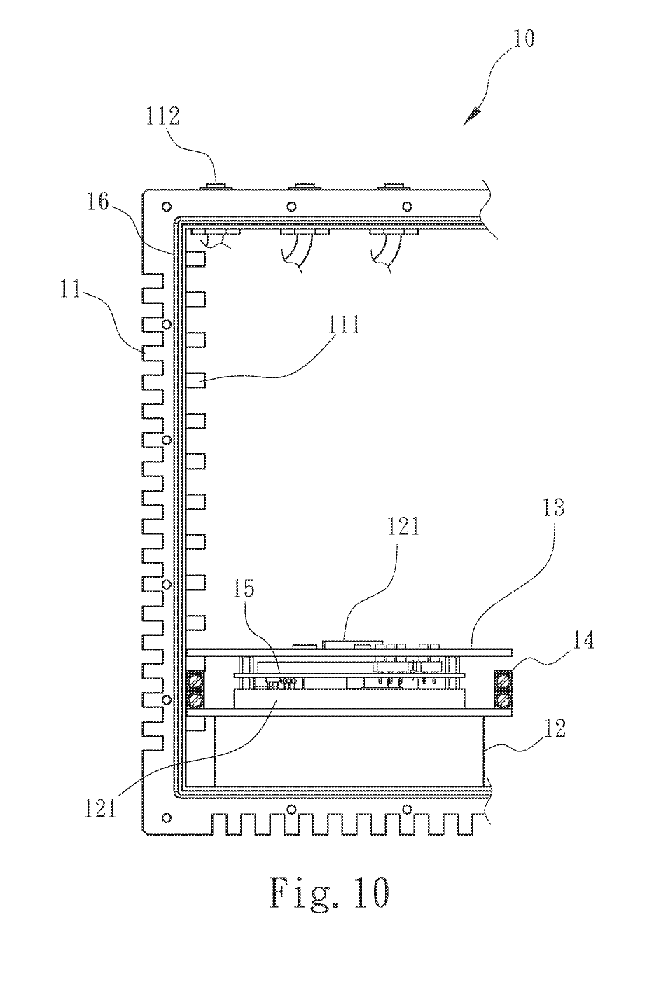

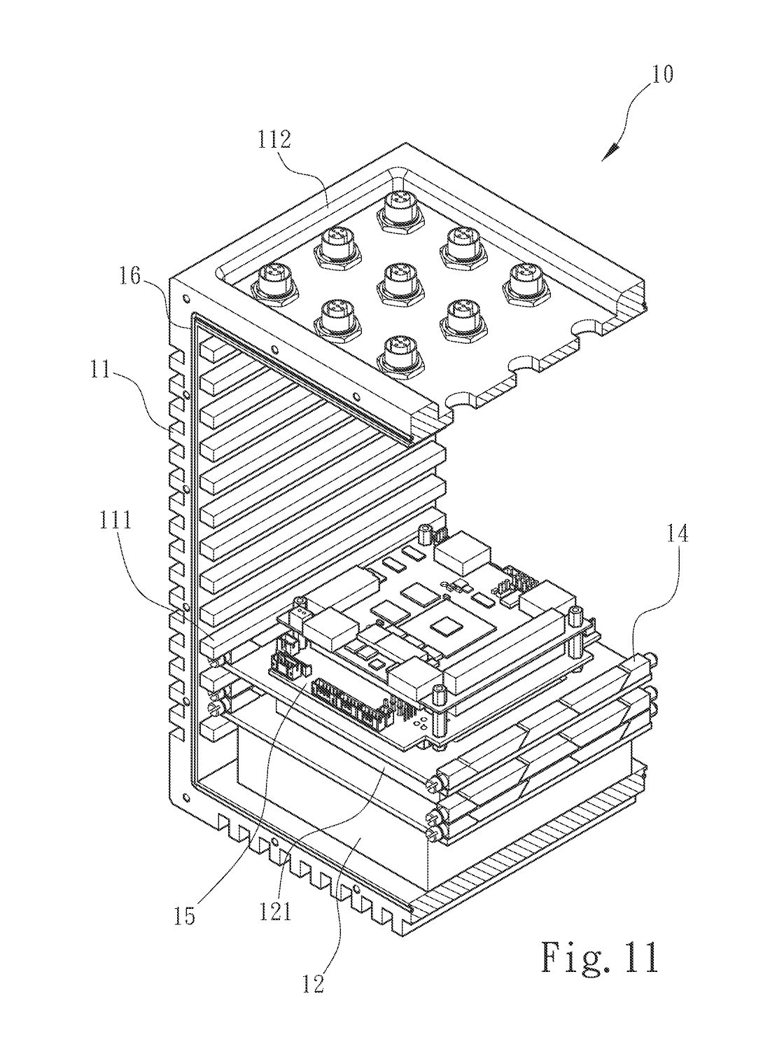

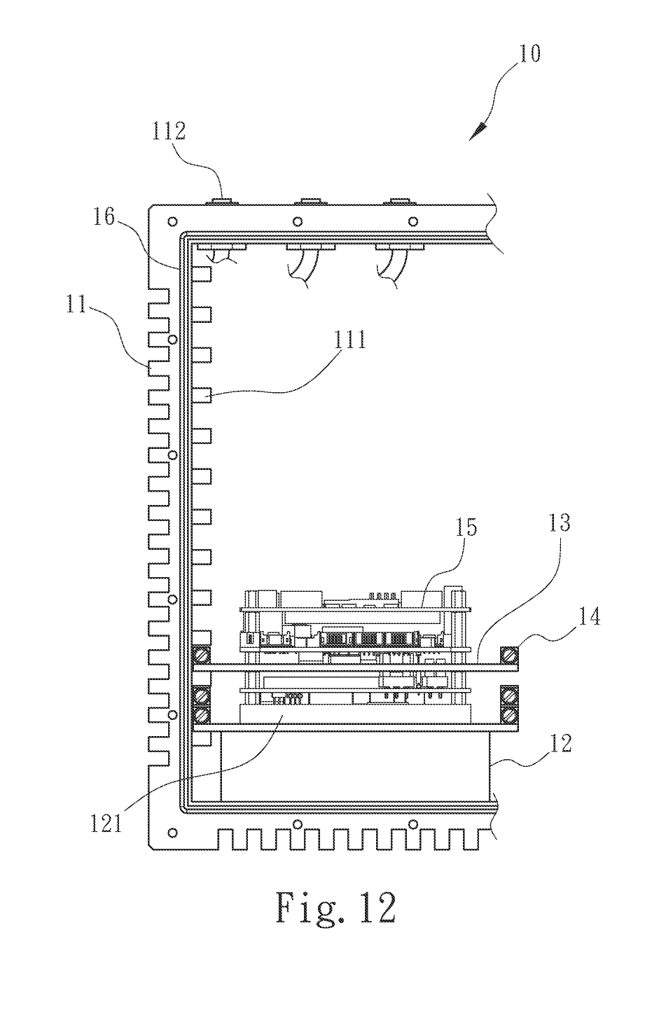

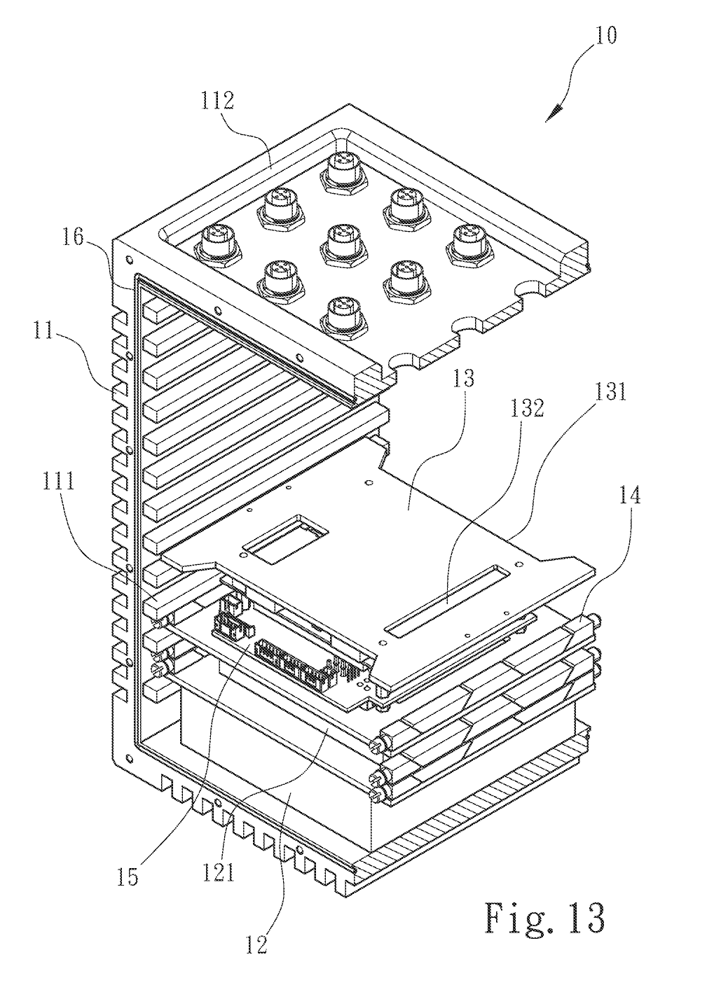

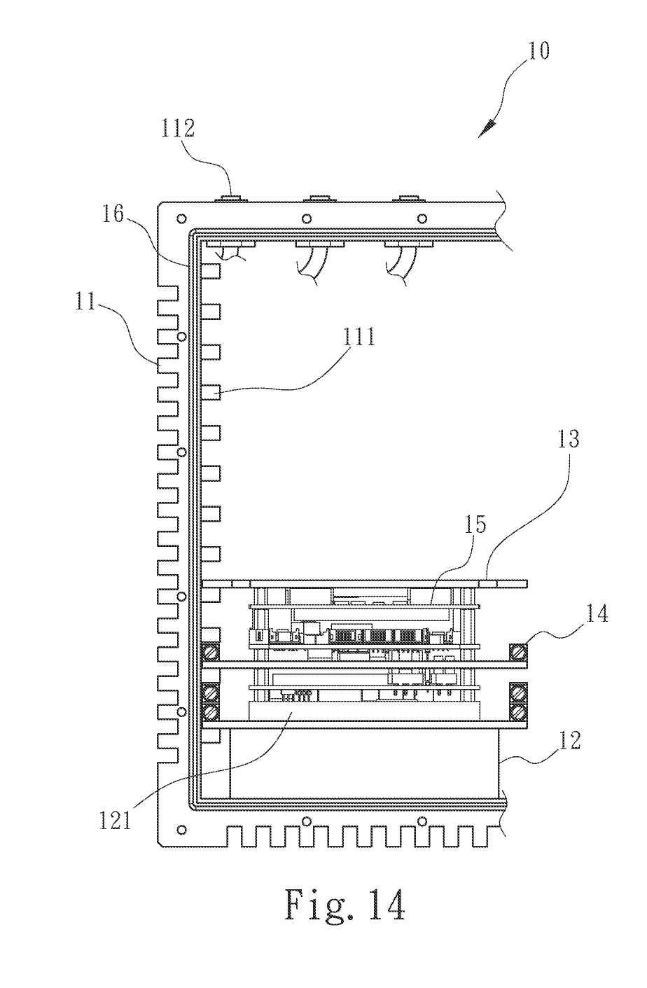

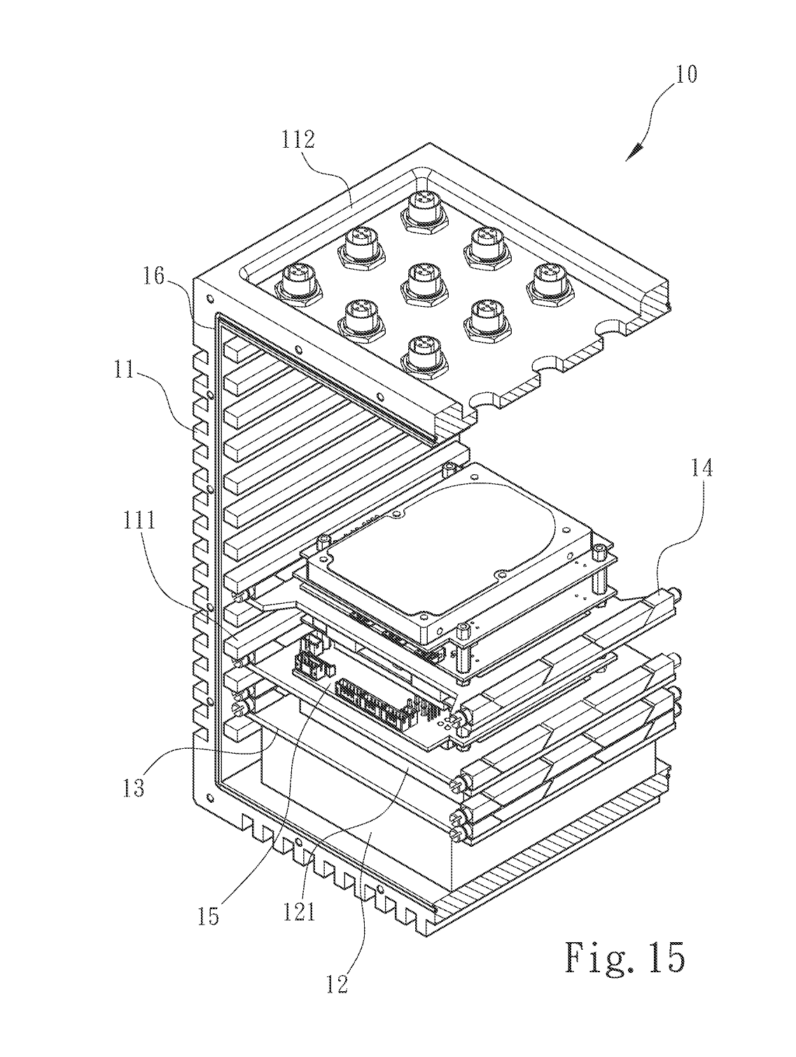

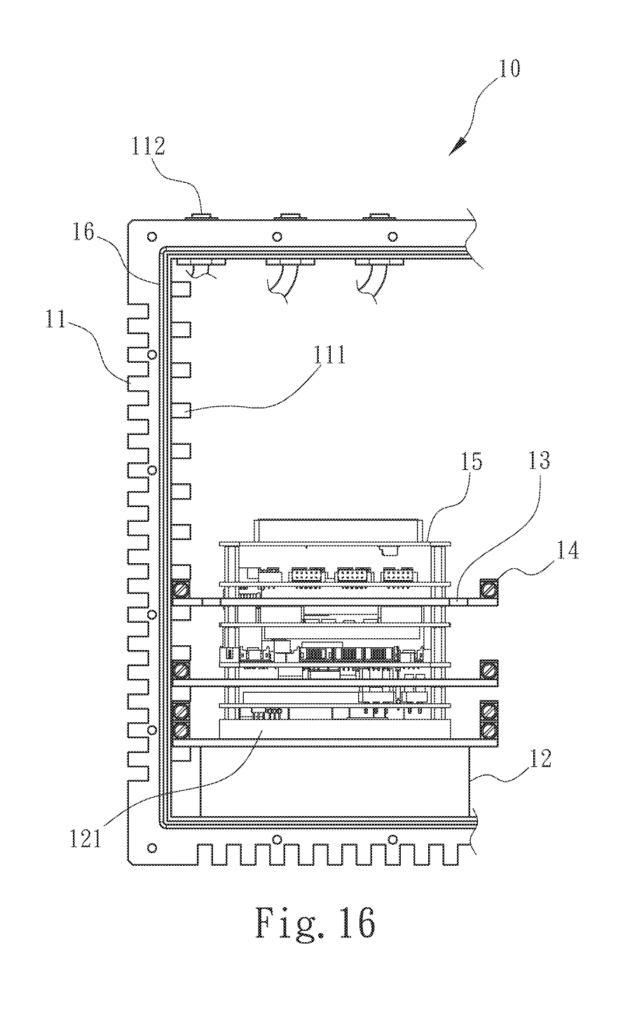

Please refer to FIGS. 3 through 16 for the assembly processes of the computer cooling module assembly of the invention. First, referring to FIGS. 3 and 4, the finned frame 11 has two corresponding planes to form a plurality of the positioning support racks 111 that are symmetrical and equally spaced from each other; at the inside bottom of the finned frame 11 a conduction base 12 is provided in contact with the heat conduction board 13 located thereabove in advance, and a plurality of positioning fasteners 14 are provided to fasten the heat conduction board 13 to the positioning support racks 111 as shown in FIGS. 5 and 6; because the conduction base 12 is in contact with the heat conduction board 13, the heat conduction board 13 at the lowest side can transmit heat to the bottom side of the finned frame 11; next, place a conduction pad 121 above the heat conduction board 13, and fasten one printed circuit board 15 to the conduction pad 121 by screwing so that the conduction pad 121 can transmit heat from the electronic elements on the printed circuit board 15 to the heat conduction board 13 as shown in FIGS. 7 and 8; next, place another heat conduction board 13 with the connector slot 132 formed thereon on another positioning support rack 111 above the printed circuit board 15 with the connector 151 on the printed circuit board 15 passing through the connector slot 132, and the heat of the electronic elements on the printed circuit board 15 can be transmitted to the fined frame 11 as shown in FIGS. 9 and 10; then, similarly, the heat conduction board 13 and the positioning support rack 111 are also fastened via the positioning fastener 14, then another printed circuit board 15 can be mounted above the heat conduction board 13 and fastened thereon, and form electric connection between the printed circuit board 15 with the one below through the connector 151 as shown in FIGS. 11 and 12; similarly, yet another heat conduction board 13 with the connector slot 132 and the conductive wire slot 131 formed thereon can be placed above the printed circuit board 15, and the conductive wire slot 131 allows a conductive wire of the telecommunication connection interface 112 to pass through the conduction board 13 to form electric connection with the printed circuit board 15 below, and the heat generated by the electronic elements on the printed circuit board 15 can be transmitted to the circumferential surfaces of the finned frame 11 as shown in FIGS. 13 and 14; similarly, the heat conduction board 13 at the upmost location can be fastened to positioning support rack 111 via yet another positioning fastener 14, and fasten still another printed circuit board 15 above the heat conduction board 13 to transmit the heat generated by the electronic elements below the printed circuit board 15 to the circumferential surfaces of the finned frame 11 as shown in FIGS. 15 and 16. When the heat conduction boards 13 at all the layers have transmitted the heat generated by the electronic elements on all the printed circuit boards 15 to the finned frame 11, the cooling tubes 16 located between the finned frame 11 and the covering boards 17 can function to speed up heat dispersion of the fins on the finned frame 11. Thus, the invention not only can transmit the heat generated by the electronic elements on the printed circuit boards 15 to the finned frame 11, the fins on the finned frame 11 also can form maximum surface area to increase heat transmission area to achieve faster cooling effect without generating noise. The invention further can incorporate with the cooling tubes 16 located between the finned frame 11 and the covering boards 17 to make cooling much faster and more substantial.

What is claimed is:

1. A computer cooling module assembly for stacked printed circuit boards to hold a plurality of stacked printed circuit boards, comprising:
an open finned frame to hold the printed circuit boards including two corresponding planes to form a plurality of positioning support racks that are symmetrical and equally spaced from each other;
at least one heat conduction board leaned on each positioning support rack to transmit heat generated by electronic elements on the printed circuit boards to the finned frame; and
two covering boards to separate the interior and the exterior of the finned frame.

2. The computer cooling module assembly of claim 1, wherein the finned frame and each covering board are interposed by a cooling tube.

3. The computer cooling module assembly of claim 2, wherein the finned frame and the covering board are formed respectively a tube installation trough and a tube butting trough in a concave and semi-arched surface fashion to couple with the cooling tube.

4. The computer cooling module assembly of claim 1, wherein each printed circuit board includes a connector to form electrical connection with another printed circuit board stacked at an upper side or a lower side, and the heat conduction board includes at least one connector slot passed through by the connector.

5. The computer cooling module assembly of claim 2, wherein each printed circuit board includes a connector to form electrical connection with another printed circuit board stacked at an upper side or a lower side, and the heat conduction board includes at least one connector slot passed through by the connector.

6. The computer cooling module assembly of claim 3, wherein each printed circuit board includes a connector to form electrical connection with another printed circuit board stacked at an upper side or a lower side, and the heat conduction board includes at least one connector slot passed through by the connector.

7. The computer cooling module assembly of claim 1, wherein the finned frame includes at least one telecommunication connection interface for the printed circuit boards to transmit telecommunication signals, and the heat conduction board includes at least one conductive wire slot passed through by a conductive wire of the telecommunication connection interface.

8. The computer cooling module assembly of claim 3, wherein the finned frame includes at least one telecommunication connection interface for the printed circuit boards to transmit telecommunication signals, and the heat conduction board includes at least one conductive wire slot passed through by a conductive wire of the telecommunication connection interface.

9. The computer cooling module assembly of claim 4, wherein the finned frame includes at least one telecommunication connection interface for the printed circuit boards to transmit telecommunication signals, and the heat conduction board includes at least one conductive wire slot passed through by a conductive wire of the telecommunication connection interface.

10. The computer cooling module assembly of claim 1, wherein the heat conduction board and the positioning support racks are interposed by at least one positioning fastener to fasten the heat conduction board.

11. The computer cooling module assembly of claim 9, wherein the heat conduction board and the positioning support racks are interposed by at least one positioning fastener to fasten the heat conduction board.

12. The computer cooling module assembly of claim 11, wherein the finned frame includes a conduction base at the inside bottom in contact with the heat conduction board, and the heat conduction board and the printed circuit boards are interposed by at least one heat conduction pad to transmit the heat generated by the electronic elements on the printed circuit boards to the heat conduction board.
